(19) United States
(12) Patent Application Publication
(10) Pub. No.: US 2006/0129823 A1
(43) Pub. Date: Jun. 15, 2006

(54) Security device

(76) Inventors: Lawrence David McCarthy, Vic (AU); Gerhard Fredrick Swiegers, Vic (AU)

Correspondence Address: LADAS & PARRY, 5670 WILSHIRE BOULEVARD, SUITE 2100, LOS ANGELES, CA, 90036-5679, US

(21) Appl. No.: 10/530,784

(22) PCT Filed: Oct. 9, 2003
(86) PCT No.: PCT/AU03/01331

§ 371 Date: Oct. 11, 2005

(30) Foreign Application Priority Data
Oct. 9, 2002 (AU) 2002951963

(51) Int. Cl. G06F 17/30; H04L 9/00

(52) U.S. Cl. 713/176; 726/31

(57) ABSTRACT

The present invention relates to a security device or a security apparatus comprising one or more primary images (103) encoded within a secondary image in such a manner that the primary images can only be observed by an observer (102) when the secondary image, a decoding mask (105) and the observer are in a predetermined alignment. Embodiments of the invention have application in the provision of security devices which can be used to verify the legitimacy of a document, instrument or the like.

### FIELD OF THE INVENTION

The present invention relates to a security device or a security apparatus comprising one or more primary images encoded within a secondary image in such a manner that the primary images can only be observed by an observer when the secondary image, a decoding mask and the observer are in a predetermined alignment. Embodiments of the invention have application in the provision of security devices which can be used to verify the legitimacy of a document, instrument or the like.

### BACKGROUND TO THE INVENTION

In order to prevent unauthorised duplication or alteration of documents such as banknotes, credit cards and the like, security devices are often incorporated as a deterrent to copyists. The security devices are either designed to deter copying or to make copying apparent once copying occurs. Despite the wide variety of techniques which are available, there is always a need for further techniques which can be applied to provide a security device.

### SUMMARY OF THE INVENTION

In a first aspect of the invention, there is provided a security device comprising:

a secondary image comprising one or more encoded primary images, each of said one or more encoded primary images comprising a plurality of regularly sized and spaced apart primary image elements; and

a decoding mask separated from the secondary image, the decoding mask having a plurality of regularly spaced apart transparent viewing portions separated by masking portions, the size and spacing of the viewing portions being such that when said viewing portions of the mask, said secondary image and an observer are located in or more predetermined alignments for each said one or more encoded primary images, the primary image elements from the secondary image may be observed through the viewing portions, whereby the corresponding primary image may be observed along a line of sight corresponding to said predetermined alignment.

In some embodiments, the secondary image comprises a plurality of encoded primary images, the primary images being arranged such that each of the primary images may be observed in different predetermined alignments of the mask, the secondary image, and the observer.

In some embodiments, each encoded primary image is arranged in at least partial overlapping relationship with at least one other primary image with at least one primary image element located within a boundary of the primary image.

In one embodiment, the encoded primary images are related and located relative to one another so as to produce an animation effect as successive primary images are observed.

In some embodiments, the colours of at least one of the decoding mask and/or at least one of said one or more primary images are chosen to enhance the effect of at least one of said one or more primary images coming into alignment.

In one embodiment, the predetermined alignment is chosen such that each of the one or more primary images cannot be observed by an observer observing the security device along a line of sight substantially perpendicular to the plane in which the decoding mask is located.

In one embodiment, there is only one encoded primary image and the decoding mask is positioned relative to said secondary image such that said primary image can only be observed by an observer observing the security device along a line of sight substantially perpendicular to the plane in which the decoding mask is located.

In another aspect, the invention provides a security apparatus comprising:

a security device adapted to be provided on or as part of an item to be secured, the security device comprising a secondary image comprising one or more encoded primary images, each of said one or more encoded primary images comprising a plurality of regularly sized and spaced apart primary image elements; and

a decoding mask having a plurality of regularly spaced apart viewing portions separated by masking portions, the size and spacing of the viewing portions being such that at a predetermined separation between the mask and the secondary image and when said viewing portions of the mask, said secondary image and an observer are in one or more predetermined alignments for each said one or more encoded primary images, the primary image elements of the aligned primary image of the secondary image may be observed through the viewing portions, whereby the corresponding primary image may be observed along a line of sight corresponding to said predetermined alignment.

In one embodiment, the decoding mask and secondary image are provided at spaced apart locations on the same piece of material in such a manner that the material can be folded so as to locate the decoding mask over the secondary image and move the decoding mask relative to the secondary image to view each of the primary images.

In a further aspect the invention provides a method of securing an item comprising:

providing a security device adapted to be provided on or as part of an item to be secured, the security device comprising a secondary image comprising one or more encoded primary images, each of said one or more encoded primary images comprising a plurality of regularly sized and spaced apart primary image elements;

providing a decoding mask having a plurality of regularly spaced apart viewing portions separated by masking portions, the size and spacing of the viewing portions being such that at a predetermined separation between the mask and the secondary image and when said viewing portions of the mask, said secondary image and an observer are in one or more predetermined alignments for each said one or more encoded primary images, the primary image elements of the aligned primary image of the secondary image may be observed through the viewing portions, whereby the corresponding primary image may be observed along a line of sight corresponding to said predetermined alignment.

### BRIEF DESCRIPTION OF THE DRAWINGS

A preferred embodiment of the invention will now be described in relation to the accompanying drawings in which:

FIG. 1 shows a secondary image of a first example;

FIG. 2 shows a mask suitable for use with both the first and second example;

FIG. 3 shows how the mask of FIG. 2 is used to reveal one of the primary images in FIG. 1;

FIG. 4 shows four original images which can be used as the basis of primary images;

FIG. 5 shows the primary images produced from the images from FIG. 4;

FIG. 6 shows the primary images of FIG. 5 combined into a secondary image;

FIG. 7 shows the secondary image of FIG. 6 wherein the white spaces are filled with random or pseudo random elements;

FIG. 8 shows an example of an alternative mask;

FIG. 9 shows the mathematical relationships between a mask and a secondary image affixed to opposite sides of a transparent plastic film.

FIG. 10 shows an original image containing information of interest for the fourth and fifth embodiments;

FIG. 11 shows the encoded primary image produced from the image in FIG. 10;

FIG. 12 shows the mask affixed in correct overlay with the secondary image in accordance with the fourth embodiment;

FIG. 13 shows the resulting image observed by a viewer positioned at an angle perpendicular to the surface of the mask and secondary image;

FIG. 14 shows the image observed by a viewer positioned at another angle, not perpendicular to the surface of the device;

FIG. 15 shows the mask when affixed in correct overlay in accordance with the fifth embodiment;

FIG. 16 illustrates how an animated effect may be achieved in a security device or apparatus in accordance with any one of the first to third embodiments; and

FIG. 17 shows a security device made in accordance with the fourth embodiment.

### DESCRIPTION OF THE PREFERRED EMBODIMENTS

The preferred embodiments provide security devices and security apparatus wherein one or more primary images are encoded within a secondary image in such a manner that the primary images can only be observed by an observer when the secondary image, an appropriate decoding mask and the observer are in a predetermined alignment.

In the security devices and security apparatus of the preferred embodiments the primary image within the secondary image is typically unintelligible so that it is not readily apparent that the one or more primary images are contained within the secondary image. When the decoding mask and the observer are correctly oriented relative to an encoded primary image, a primary image can be observed by an observer. In embodiments where there is more than one primary image, by altering the relative position of the observer and/or the mask and/or the secondary image, each of the primary images can be viewed.

Herein, the term “secondary image” does not imply that the secondary image contains an observable image of, for example an object, rather, the term “secondary image” is used to refer to a set of image elements which contains within its borders at least the primary image elements of each of the one or more encoded primary images. That is, depending on the embodiment the secondary image may also contain additional image element or itself be contained within another image. The term secondary image is used to refer to the image containing the encoded primary images irrespective of whether the secondary image has been subject to further modification after the encoded primary images have been combined as may occur in some embodiments.

Depending on the embodiment, all parts of the secondary image need not necessarily be located in the same plane. Thus, it is possible to form a device or apparatus where there are multiple layers for the second image each having different separations from the decoding mask. For example, in a secondary image comprising two encoded primary images one encoded primary image may be located in one plane and the other may be located in another plane. Similarly, portions of one primary image may be located in mulitple planes.

Similarly, the term “primary image” is used to refer to whatever is observed by an observer when the decoding mask, the encoded primary image and the observer are in alignment, irrespective of whether this is an image of an object.

Accordingly, it will also be appreciated that the term “encoded primary image” is used to refer to the set of image elements which will allow the primary image to be observed.

The “image elements” are typically pixels (i.e. the smallest available printing element). However, each “image element” may consist of a group of pixels—e.g. a 2×2 array of pixels.

The term “security device” is used to refer to embodiments of the invention where the decoding mask is fixed relative to the secondary image. Such devices can be formed for example, by forming a laminate of layers of material on which each of the decoding mask and secondary image are printed, by printing them on opposite sides of a piece of transparent material or, by printing them at different levels within a piece of transparent material. Accordingly, the primary image hidden within the secondary image can be viewed by the observer moving or by tilting the security device relative to the observer. used to refer to embodiments where the decoding mask can be physically moved relative to the secondary image. In this case, the relative movement of the two surfaces relative to one another at a predetermined separation will allow each of the one or more primary images to be viewed. The components of such security apparatus need not necessarily be physically separate to one another as will be described in relation to the third embodiment.

### First Preferred Embodiment

In each of the variants of the first, second and third preferred embodiments, there are a plurality of primary images combined within the secondary image. Further, each image element is made of a small size. It is preferred that the area of each image element is in the range 1×10⁻¹²m² to 2.5×10⁻⁹m² although image elements of area up to 4×10⁻⁸m² may be acceptable in some embodiments. Further, if printing techniques allow, it would be desirable to print at sizes down to 1×10⁻¹⁴m². This corresponds for square image elements where the sides of each square have a length in the range of 0.1 μm to 200 μm.

In any physical embodiment, a clear picture of one of the primary images can only be perceived by the observer when all, or most of the viewing portions of the mask overlap perfectly with all or most of the image elements belonging to one of the primary images within the secondary image. If the physical size of the viewing portions in the decoding mask differ from the physical size of the image elements in the secondary image either in reality or in perspective (if a space is present between the mask and the secondary image), it becomes impossible to correctly align all or most of the viewing portions of the mask with all or most of the primary image elements belonging to one of the encoded primary images in the secondary image. The observer cannot then perceive any of the primary images clearly. Successful production of the effect therefore depends on correctly and precisely matching the physical dimensions of the viewing portions in the mask with the image elements in the secondary image.

When the viewing portions on the mask and the image elements in the secondary image are very small, that is within the range of 0.1 μm to 200 μm, the effect of mismatches in their dimensions is greatly exaggerated. This is because even a relatively small overall secondary image, say of 5 cm×5 cm dimensions, requires many viewing portions in the mask and image elements in the secondary image. Even small mismatches in their dimensions therefore cause substantial displacement errors to occur in traversing the large number of image elements present.

In a security device or security apparatus containing dimensionally identical mask viewing portions and secondary image elements, the effect of altering the relative positions of at least two of the mask, the secondary image and the observer is to create a sequential change in the primary images perceived by the observer. The rate of this sequential change is characteristic of, and dependent upon the dimensions of the mask viewing portions and secondary image elements, all other features remaining invariant. Thus, changes in these dimensions also increase or decrease the speed with which the primary images are perceived to sequentially change by the observer. Variations in the speed of this sequential change can be extremely evident to the observer. For example, where an animation effect involving the successive observation of closely related primary images is employed, the speed of the animation will be a distinctive characteristic of the system. Changes in the speed of animation can therefore readily distinguish an original from a copy, even if the images employed in the animation are identical.

In embodiments such as the first embodiment where the mask is provided on one side of a sheet of transparent material with the secondary image affixed (e.g. by printing) to the other side of the transparent material, the rate of the sequential change of the primary images perceived by the observer during rotation of the security device is also dependent on the thickness of the sheet and its refractive index.

Thus, the primary images can be correctly and characteristically observed only when the secondary image and the mask are constructed to exact, miniature, design and dimensions.

As all known reproduction and copying techniques produce errors, to lesser or greater extents, in the dimensions and resolution of the copied portions, these limitations offer a means to deter counterfeiting or identify where it has taken place.

In particular, these small sizes offer substantial protection against “casual counterfeiting” using color photocopiers, computer scanners and the like. With the small dimensions involved, the errors introduced by using this machinery will introduce errors in the manner of which one image transforms to the next image which will become noticeable as staccato or interrupted changes. Furthermore, it is possible to select the resolution using a printing technique to be different to that conventionally used by photocopiers or digital image acquirers such as scanners and digital cameras. For example, the picture resolution of such devices is typically an even number—(e.g. 240 dpi) whereas it is possible to choose an unusual picture resolution—(e.g. 257 dpi) which makes the image extremely difficult to capture.

In the first preferred embodiment, a security device is provided having a decoding mask which has a plurality of regularly spaced apart viewing portions. To form a secondary image, a plurality of encoded primary images, each consisting of a plurality of primary image elements having corresponding spacing to the viewing portions are also provided. The relative size of the viewing portions and primary image elements is chosen depending on the separation of viewing portions and image elements. However, they may be chosen to be the same side. The encoded primary images are then combined to form a secondary image. The encoded primary images are combined in such a manner that the image elements of the primary images do not overlap. The viewing portions of the mask are separated by masking portions which mask the image elements of the other encoded primary images when the viewing portions are located over the image elements of one of the encoded primary images whereby the corresponding primary image can be observed.

To form the security device, the mask is applied to one side of a piece of transparent material with a secondary image applied to the other side. By moving the piece of transparent material relevant to the observer, the different primary images can be viewed. This is particularly useful where it is desired to have the secondary image produces an animated effect—i.e. it is possible to incorporate a number of related original images into the secondary image so that as they are successively viewed the image appears to change.

In this embodiment, the primary image which is observed by the observer when the primary image elements, the viewing portions and the observer are in alignment is recognisable by the observer as a version of the original image as the masking portions of the decoding mask decode the encoded primary image supplement the information carried by the encoded primary image to enable the primary image to be observed.

The secondary image and the decoding mask can be formed in a number of different ways. For example, a secondary image may be formed by interleaving and overlaying n primary images, where n is an integer (n≧2). Each of the primary images to be included in the secondary image is formed by taking an original image and digitising it to produce a digitised original image consisting of a plurality of pixels. The pixilated original images are then modified in order to produce the encoded primary image so as to allow them to be combined to create a secondary image.

Essentially, each of the original images is modified by removing sufficient pixels to accommodate pixels of each of the other primary images in areas where the primary images overlap one another. For example, an original image can be modified by laying the chosen mask over the top of the original and keeping only the pixels which fall within the viewing portions of the mask. The remaining pixels are the “primary image elements” of the encoded primary images.

Once the individual encoded primary images have been obtained they can be combined into a secondary image by offsetting them relative to one another such that they do not overlap.

A further alternative technique of interleaving and overlaying may also be used to form the secondary image. In this technique, the primary images are combined into one image prior to the application of an interleaving algorithm. For example, if one wishes to interleave primary images, each containing a different letter A, B, C, or D, then an original image consisting of a repeating array of these different symbols—the letters A, B, C and D, or the like is created. The original image is then reconstituted into a p×q matrix of pixels where p and q are integers using methods known to the art. An algorithm is then applied to the image to form the secondary image. Such an algorithm can include the mathematical scaling down and interleaving of a matrix to a non-integral fraction of its original form, e.g. 0.101p×0.101q. In doing so a new pixel matrix is created for in which the letter arrays employed in the primary images have now become mathematically interleaved and virtually unrecognisable. Pixels or groups of pixels in this image may appear to have different grey-or intermediate colour tones as a result of the interleaving process.

A secondary image containing pixels, none of which are blank and all of which originate from an individual pixel of only one of the primary images, is thus obtained.

A mask is created by converting all of the blank pixels in one of the primary images to black pixels; the remaining pixels are converted to white. The white pixels are subsequently printed as transparent pixels in order to provide viewing portions.

A further alternative technique of interleaving and overlaying may also be used to form the secondary image. Original images consisting of an array of multiple different symbols—e.g. the letters A, B or C or the like are created. Each of the original images is reconstituted into a p×q matrix of pixels where p and q are integers using methods known to the art. The physical size of each of the pixels, in each of the original images is identical to those of the other original images. An algorithm is then applied to each original image to form the primary image. Such an algorithm can include the mathematical scaling down of a matrix to a non-integral fraction of its original form, e.g. 0.10p×0.10q. In doing so a new pixel matrix is created for each original image in which the letter arrays employed in the primary images have now become mathematically interleaved and virtually unrecognisable. Pixels or groups of pixels in these images may appear to have different grey-or intermediate colour tones as a result of the interleaving process. The primary images which have thus been created are now overlayed side by side with the other primary images in a repeating fashion to create the secondary image.

A mask is created by converting all of the blank pixels in one of the primary images to black pixels; the remaining pixels are converted to white and printed as transparent pixels to thereby form the viewing portions.

While a range of techniques can be used to interleave and overlay images to form the secondary image, in all cases the techniques must be contrived so as to allow a mask having a plurality of viewing portions to render exclusively one of the primary images observable in at predetermined alignments of the mask, the secondary image and the observer.

The original images which can be used to form primary images or the primary images themselves can be graphical depictions of text, colours, portraits or images of people, animals, maps, geographical features, coats of arms, or other suitable images. The primary image may be repeated versions of a single image. Further, the primary images may be created directly in a form suitable for combining into the secondary image.

The secondary image may be either readily recognisable or unintelligible depending on the desired application. Further, where it is desired to render the composite image unintelligible random or pseudo-random elements may be introduced into the secondary image to render it less intelligible.

A number of different techniques including printing, engraving, embossing, moulding, digital and photographic techniques can be used to produce the secondary images and the decoding mask. Such techniques will be well known to persons skilled in the art.

Colours may be used in either the secondary image or the mask in order to achieve colour-shifting effects in which the movement of the mask over the composite image produces characteristic sudden or gradual changes in colour.

By combining highly contrasted primary images into the secondary image, flash illumination of multiple images may be achieved. For example, primary images of brightly highlighted messages or images are combined with poorly highlighted primary images in the composite image. When a mask is moved relative to the face of the secondary image, the brightly highlighted images are observed to flash sequentially and noticeably.

Masks and images of different colours can be used to obtain a wide variety of colour primary images.

Some degree of coloured transparency can also be used. With transparency a greater range of colours can occur as light passes through the coloured sections of the encoded primary images and coloured sections of the mask.

By combining opaque and transparent printing a greater resistance to counterfeiting could be achieved.

Also other variations can be applied or used in combination such as multiple colours in the image and mask. The colour variation can be applied both horizontally and vertically to the decoding mask and image so that different colour shifting can occur with the device is tilted side to side or top to bottom or somewhere in-between.

Different masks may be used in different applications. For example, for six primary images, where the image elements are pixels, one pixel in every group of 2×3 pixels should be a viewing portion. Further, it is not necessary for the invention to be embodied by a rectangular array either—for example, the viewing portions and image elements could be hexagonal.

This embodiment can be used to increase the security in anti-counterfeiting capabilities of items such as tickets, passports, licences, currency, and postal media. Other useful examples of items may include credit cards, photo identification cards, tickets, negotiable instruments, bank cheques, traveller's cheques, labels for clothing, drugs, alcohol, video tapes or the like, birth certificates, vehicle registration cards, land deed titles, visas, and consumable products.

### Second Preferred Embodiment

In the second embodiment, the invention is provided as a distributed apparatus where the decoding mask is provided separate to the secondary image.

Typically, the secondary image would be incorporated within a document, such as a passport and the decoding mask would be provided to people such as immigration officers who are required to check the authenticity of the document. The decoding mask would typically be presented on one side of a piece of transparent material corresponding to the predetermined separation distance at which the primary images will be observable. The security image can be hidden within the primary document so that a counterfeiter is not necessarily aware of its presence. Without having an authorised decoding mask, the counterfeiter will not be able to determine that they have produced an appropriate screen.

As with the first embodiment, the primary images can be chosen if desired, to produce an animation or flash illumination effect when the screen is moved relative to the observer and the secondary image. Typically, by passing the screen over the document including the security device.

### Third Preferred Embodiment

In a third embodiment otherwise constructed in accordance with the second and first embodiment, security apparatus is provided in which the mask and the secondary image to be carried by the same piece of material in such a manner that the mask can be applied over the secondary image by folding the material. For example, the secondary image could be located at one end of a bank note and the mask located at another end in such a manner that when they are folded over they reveal the secondary image to thereby provide verification of the validity of the banknote.

### Fourth Preferred Embodiment

The fourth embodiment provides a security device where one or more primary images are combined into a secondary image, and the decoding mask is fixed relative to the secondary image in such a way that the primary image containing the information of interest is not visible when the observer is positioned substantially perpendicularly above the surface of the mask/secondary image. That is to view the primary image or image encoded within the secondary image which contains the information of interest, the observer needs to be positioned at an angle to the perpendicular.

Each of the one or more encoded primary images to be included in the secondary image is formed by taking an original image and digitising it to produce a digitised original image consisting of a plurality of pixels. The pixilated original images are then modified in order to allow them to be combined to create a secondary image. Persons skilled in the art will appreciate that a digitised image may also be used as an original image. In this embodiment, as explained in more detail below it is only necessary for a single primary image to be incorporated within the secondary image in order to obtain anti-counterfeiting benefits.

As with the other embodiments, the original images which can be used to form primary images which can be graphical depictions of text, colours, portraits or images of people, animals, maps, geographical features, coats of arms, or other suitable images. Further, the primary images may be created directly in a form suitable for combining into the secondary image.

Accordingly, an appropriate technique for producing a single encoded primary image is to modify an original image by laying the decoding mask over the top and keeping only the pixels which fall within the viewing portions of the mask—i.e. the remaining pixels are set to be blank/transparent.

However, in a variant on the embodiment, two or more encoded primary images may be incorporated within the secondary image using any of the techniques outlined in relation to the first embodiment.

As indicated above, the mask and the secondary image are affixed in a suitably separated overlay to opposite sides of a separator in the form of a piece of transparent material—e.g. by printing them on either side of the transparent material. In a preferred variant of this embodiment, an additional blocking mask is located on the opposite side of the secondary image by laminating a piece of material having the blocking mask thereon to the material.

In another preferred variant, the mask (or both masks) and the secondary image are printed within the transparent material at different depths in order to avoid tampering.

The separated overlay is chosen so that the primary image containing the information of interest is not observable when the observer is positioned perpendicularly or near-perpendicularly above the surface of the security device. To view the primary image containing the information of interest, the observer must be positioned at an angle to the perpendicular. This prevents the primary image from being acquired by laying the security device flat on an image acquirer such as a photocopier.

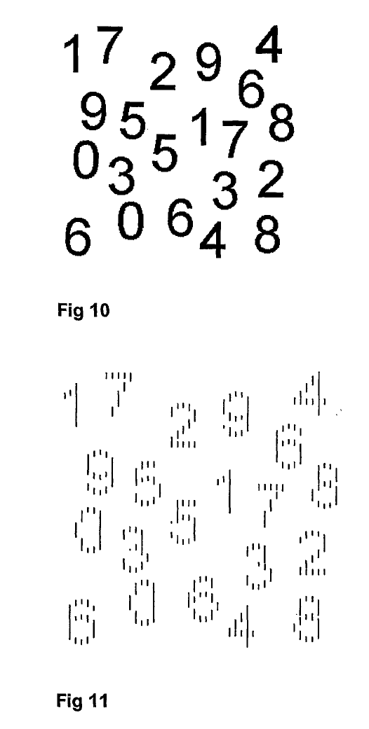

The fourth embodiment will now be described further in relation to FIG. 10. FIG. 10 shows an original image containing information of interest. This original image consists of square image elements in the form of pixels. The square elements do not have to be the same size as the mask elements however; for worthwhile interleaving to occur the image must be larger than the elements of the mask.

The original image is manipulated by using an algorithm to make blank (transparent) five out of every six pixels to form the encoded primary image shown in FIG. 11. As can be seen, for each pixel left undisturbed, five pixels have been made blank in the right-hand direction. In this example of the fourth embodiment, this single primary image provides the secondary image.

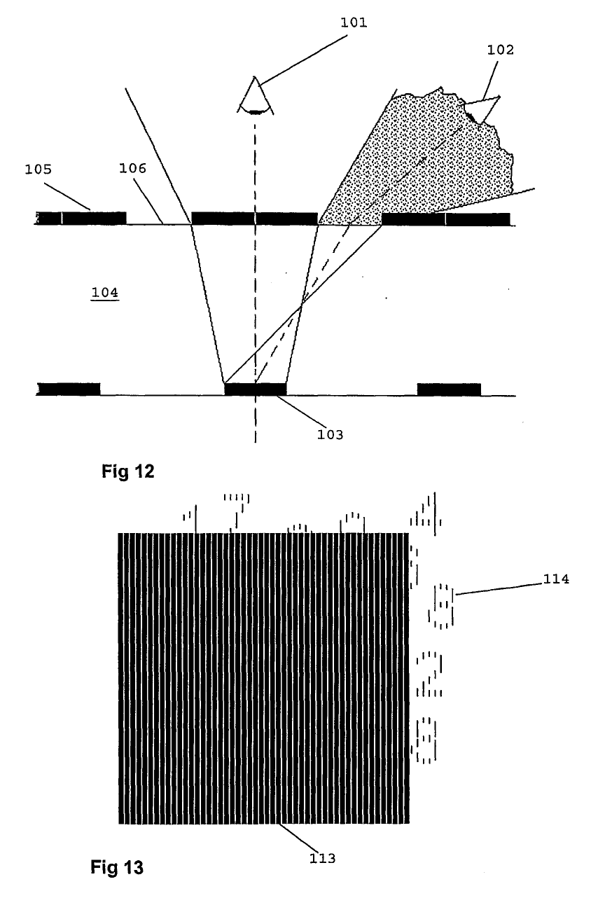

The decoding mask consisting of a repeating pattern of five opaque lines and one transparent line each one image element within is now overlaid upon the secondary image, with a suitable separation as illustrated in FIG. 12. For example, the secondary image may be printed on one side of a transparent portion of a credit card, with the mask printed in correct register on the other side.

FIG. 12 schematically illustrates the effect for a first observer 101 positioned approximately perpendicularly above the overlaid secondary image and mask and a second observer 102 at a position where the primary image can be observed. As can be seen, the primary image information of interest is not visible to the first observer 101, but is visible to the second observer 102. Thus, attempting to photocopy the device will yield only an image of the mask. FIG. 13 illustrates the view seen by the first observer, or upon photocopying, where only a section 113 of the decoding mask is shown in order to illustrate the position of the primary image 114.

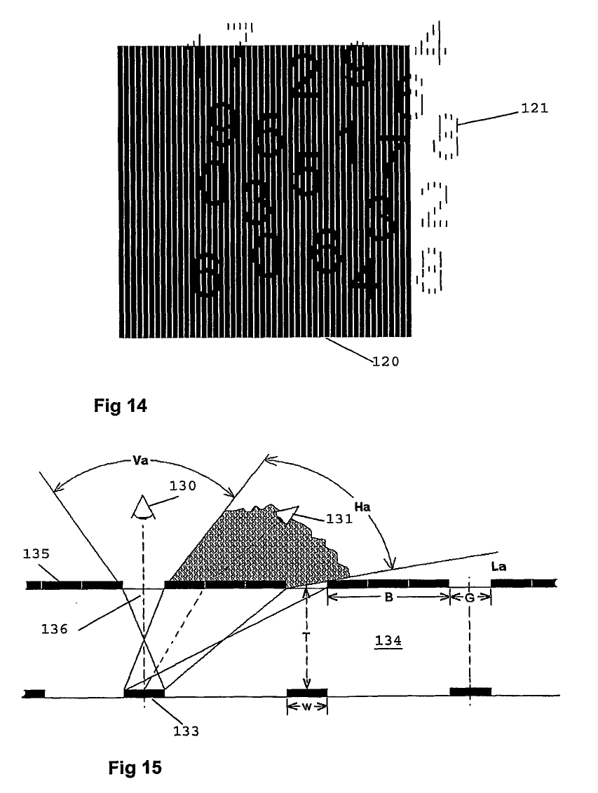

FIG. 14 illustrates, in partial cut-away form, the view seen by a second observer 103 positioned at an angle to the perpendicularly above the secondary image and mask. As can be seen, the information of interest is visible in those areas where the mask 120 overlies the encoded primary image 121.

If:

w=the width of the image elements 103

T=the thickness of the spacing media 104

B=the combined width of the opaque mask elements 105

G=the width of the transparent sections of the mask 106

Ri=the refractive index of the spacing media

Va=the angle over which some of the image is visible

Ha=the angle over which none of the image is visible

La=the angle over which a secondary non-viewing zone occurs

The hidden angle, the viewing angle and a second hidden angle are defined by the following equation.
Ha=2a sin(Ri sin(a tan((B−w)/2T)))
Va=a sin(Ri sin(a tan(G/T+(B+w)/2T)))−Ha/2
La=90° Ha/2−Va
Notice:

(1) If (Ha/2+Va)>90° then La does not exist.

(2) If both Va and Ha are small then a number of viewing zones are possible.

Ha becomes smaller as B becomes smaller and w and T become larger.

Va becomes smaller as B,w and G become smaller and T becomes larger.

(3) If (Ha/2+Va)=90° then: sin( atan(G/T+(B+w)/2T))=1/Ri

Therefore if the spacing media has the same Ri as the surrounding media (1/Ri=1) then a secondary hidden zone must exist (and hence a possible additional viewing zone) unless T is reduced to zero. If the spacing media has a higher Ri than the surrounding media (1/Ri<1 the typical case) then the secondary hidden zone can be reduced to zero while T>0.

At La=0:

T=(G+(B+w)/2)/tan( asin(1/Ri))

Typical polymers suitable for use in embodiments of this invention have a Ri˜1.5 at Ri=1.5 therefore tan (asin(1/Ri))˜0.89.

In a typical application, the security device is designed with the image and mask to be printed on each side of a plastic card including a transparent portion, the size of a typical credit card (85 mm×53 mm). The security device was to be used at a normal viewing distance when held in the hand. This is typically a distance of approximately 250-400 mm. At this distance 20 point characters are easily read. About 20 characters of this size can be pseudo-randomly distributed over a square 32 mm×32 mm.

For such an application, the mask has opaque lines 533 micron wide and transparent gaps 107 microns wide (5:1 ratio). These images are then used to produce the encoded image as shown in FIG. 11.

Applying the equations given above using the values:

B=533 micron

G and w=107 micron

T=600 micron (Typical card thickness)

Assume the card material is polyethyleneterephthalate (PET) with Ri of 1.57

gives:

Hidden angle Ha=63.4°

Visible angle Va=33.9°

Secondary Hidden angle La=24°

Two viewing directions are possible; right and left of perpendicular.

Additionally, the regular line arrayed mask shown can be constructed so as to produce Moire patterns when photographically copied.

If the security device is incorporated in a credit card, the authenticity of the credit card can be verified by requesting the bearer to provide some of the information of interest which-has been placed on the credit card. For example, the bearer may be asked “What is the number in the bottom left of your card?” If the bearer answers “six”, this conforms to the expected number seen in FIG. 11 and provides evidence that the original card is present. Numerous questions of this type, involving the random selection of information of interest can be used to establish the presence and authenticity of the card with increasing certainty. For example, the card can be placed within a frame and a particular portion of the security device identified as containing the code number of interest by its position relative to the frame.

In a variation of this embodiment two or more primary images are incorporated within the secondary image and the mask is fixed such that neither of the image can be viewed as the perpendicular or near-perpendicular. By moving the piece of transparent material relative to the observer, the different primary images can be viewed.

As most reproduction and copying techniques rely on capturing an image visible from one point in space, the incorporation of multiple images, viewable only from different points in space render devices of the kind described in this application resistant to reproduction. Additionally, successful reproduction or copying of the present invention also requires the use of a transparent sheet of the correct thickness and refractive index, along with a correctly patterned mask or masks and a secondary image which have been reproduced in exact dimensional accuracy. These limitations further deter successful counterfeiting.

Techniques may be used to disguise the presence of the primary images in the secondary image. For example, extra image elements may be added to the secondary image to disguise the primary images. For example, where the image elements are coloured pixels, randomly coloured pixels may be added to the secondary image.

Finally, the device may employ coloured secondary images and/or masks and be so constructed as to interfere with widely available copying methods by generating, for example, Moire patterns when photographed with a digital camera or video camera.

### Fifth Preferred Embodiment

The fifth embodiment of the present invention is a variant on the fourth embodiment where only a single encoded primary image containing information of interest is included in the secondary image. The original image and encoded primary image containing information of interest shown in FIGS. 10 and 11 respectively are suitable for use in this embodiment.

The key difference to the fourth embodiment is that the decoding mask and secondary image are overlaid and separated so that the primary image of interest may only be observed when the observer is in a substantially perpendicular position relative to the plane of the security device.

Referring to FIG. 15, it is clear that observer 130 can see the information of interest, but observer 131 cannot. If:

w=the width of the image elements 133

T=the thickness of the spacing media 134

B=the width of the opaque mask elements 135

G=the width of the transparent sections 136 of the mask

Ri=the refractive index of the spacing media

Va=the angle over which some of the image is visible

Ha=the angle over which none of the image is visible

La=the angle over which a secondary viewing zone may occur

Va=2 asin( Ri sin( atan((G+w)/2T)))

Ha=asin(Ri sin( atan(B/T+(G−w)/2T)))−Va/2

La=90°-Va/2−Ha

Notice:

(1) If (Va/2+Ha)>90° then La does not exist.

In practice if La is small the secondary image will be invisible because of surface reflection.

(2) If both Va and Ha are small then a number of viewing zones are possible.

Va becomes smaller as G and w become smaller and T becomes larger.

Ha becomes smaller as B and G become smaller and w and T become larger.

(3) If (Va/2+Ha)=90° then: sin( atan(B/T+(G−w)/2T))=1/Ri

Therefore if the spacing media has the same Ri as the surrounding media (1/Ri=1) then the only way of preventing a secondary viewing zone is to reduce T to zero.

For a security device having the same dimensions described in relation to the first embodiment—i.e.

B=533 micron

G and w−107 micron

T−600 micron

R₁=0.57

Visible angle, Va=32°

Hidden angle, Ha=Indeterminate therefore greater than 74° (90−32/2)

2nd. Visible angle La=non existent

In practice the visible angle is narrower as a reasonable amount of the number information has to come into view for the observer 130 to distinguish the numbers.

Using a viewer's head width of 180 mm, and viewing from 400 mm, the angle obscured by the viewer's head would be ˜25°, even though this is only ˜75% of the calculated visible angle (˜32°). In practice the numbers could not be discerned by a second viewer looking from behind just past the first viewer's head. Nevertheless if further security was sought the first viewer could move closer to less than 314 mm and completely fill the calculated viewing angle.

Examples of the present invention will now be described to further facilitate understanding of the invention. Example 1 and 2 illustrate the principle and a method of combining primary images into a secondary image in accordance with the first to third embodiments.

### EXAMPLE 1

Example 1 shows a secondary image in which four primary images consisting of a grid of individual image elements in the form A, B, C and D have been overlayed upon one another in such a manner that they do not overlap.

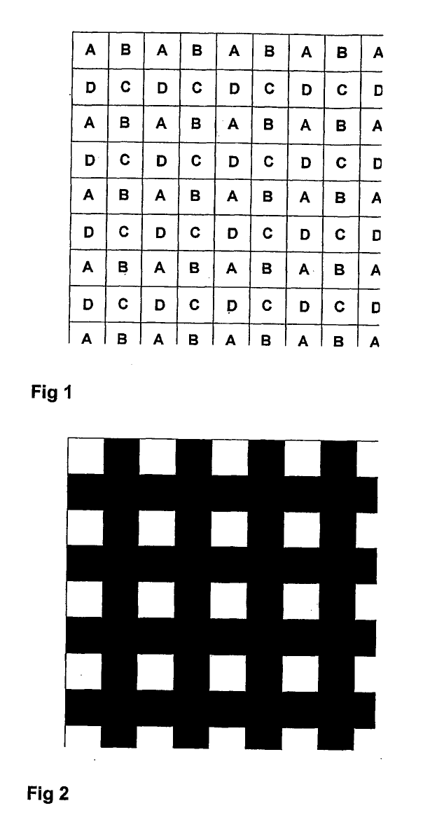

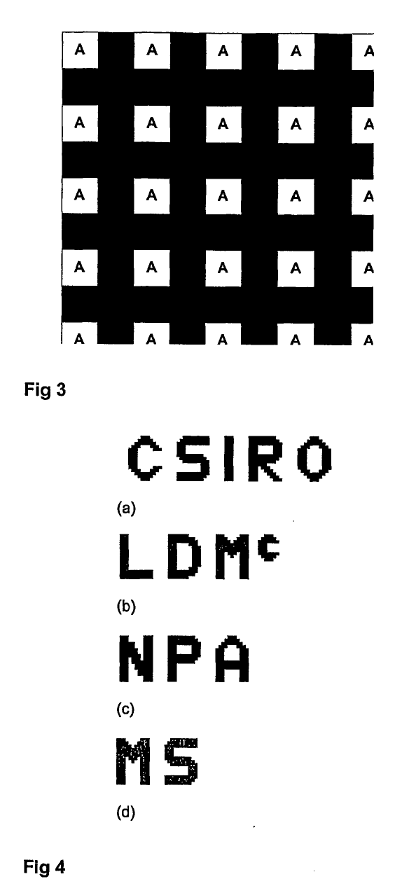

FIG. 2 shows a mask which has a plurality of viewing portions 5 separated by image obscuring portions 6. As shown in FIG. 3, when the mask is properly located over the secondary image 1, all of the A elements are visible. Similarly, if the mask were to be displaced to the right by one pixel all of the B elements would be visible. Each viewing portion has identical dimensions, either in reality or in perspective (if a space is present between the mask and the secondary image) to the image elements in FIG. 1.

### EXAMPLE 2

FIG. 4 shows four original images. These images are prepared out of square elements having the same size as the mask shown in FIG. 2. The square elements do not have to be the same size as the mask elements however; for worthwhile interleaving to occur the images must be much larger than the elements of the mask.

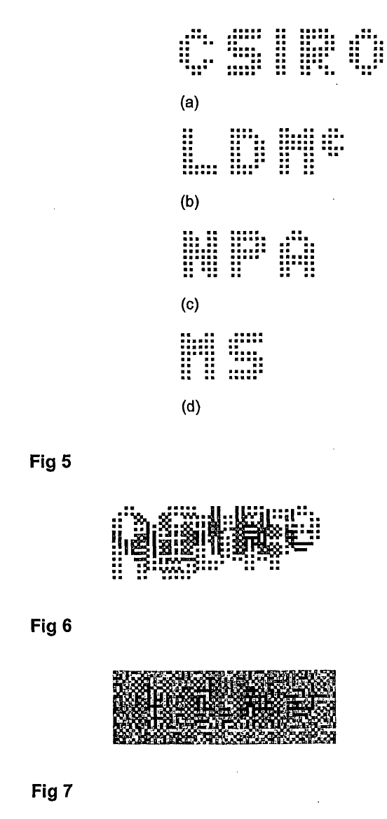

These elements are manipulated by using an algorithm to make blank 3 out of every 4 pixels to form the primary images shown in FIG. 5. As can be seen, for each pixel left undisturbed, one pixel has been made blank in the right-hand direction, one in the down direction, and one in the direction of one pixel space to the right and one pixel space down.

These primary images are then overlayed upon each other in such a manner that the image elements (i.e. the pixels) do not overlap as shown in FIG. 6. It will be apparent in this Figure that the image 5(d) has been registered twice.

In FIG. 7 the white background of the image in FIG. 6 has been obscured by placing further elements to fill all of the white spaces. It will thus be apparent that each of the primary images is effectively obscured within the image. However, when the mask is overlayed there is sufficient legibility to allow the image to be perceived.

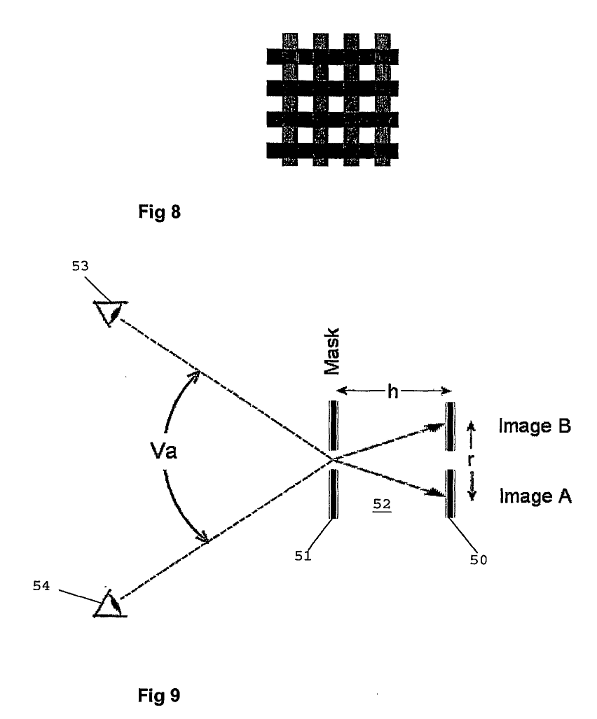

Persons skilled in the art will appreciate that various modifications can be made to the present invention without departing from the scope of the invention. For example, masks using shades or colours as shown in FIG. 8 may be used in order to improve contrast to allow the images to be better perceived.

### EXAMPLE 3

FIG. 9 illustrates how the anti-counterfeiting properties of a security device are enhanced by producing a secondary image 50 and its mask 51 on opposite sides of a transparent substrate 52, such as a plastic film as shown in FIG. 9. In this state, the thickness of the film, h, as well as the dimension of the image elements in the secondary image, r, both influence the extent of movement required in the observer from position 53 to position 54, in order to go from viewing one of the primary images in FIG. 5(a)-(d) to the next. Thus, the characteristic rate of change between the primary images observable by the viewer in rotating the film depends upon its thickness and the dimension of the image elements in the secondary image and of the viewing portion in the mask.

The angle of vision subtended for a transition (i.e. the angle between positions 53 and 54) is defined by the equation:
Va=2a sin(Ri sin(a tan (r/2h)))
Where Ri is the refractive index of the spacer.

Hence if r=20 μm, h=90 μm, and R1=1.57 m, Va²20°. Hence at a viewing distance of 150 mm the observer must move their hand approximately 53 mm if the mask is held still.

In such a device, the counterfeiter would have to copy FIG. 9 and its mask in their precise and exact original dimensions upon an identical plastic film of the precise thickness, 20 μm, to achieve the recognisably and characteristic switching of the primary images as observed in the original. These demands strongly protect the device from counterfeiting.

### EXAMPLE 4

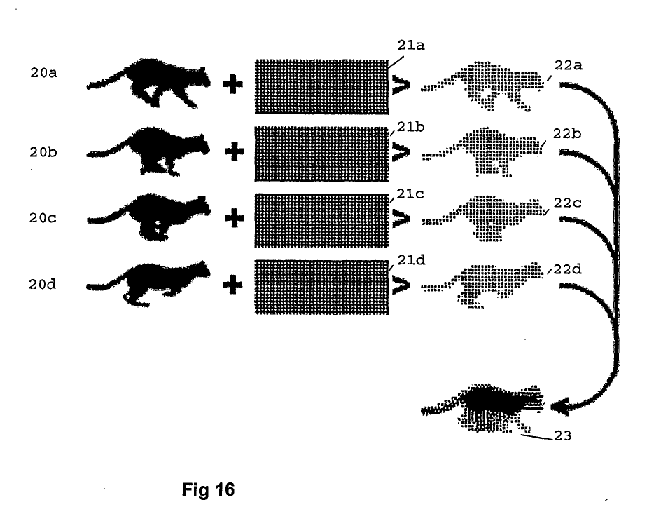

FIG. 16 illustrates how an animated effect may be achieved in a security device or apparatus in accordance with any one of the first to third embodiments.

Four images 20a-20d in sequence form an animation of a running cat were selected.

Four screening masks 21a-21d were prepared; these only differ in that they are offset by one pixel with respect to each other as a sequence starting from the first screen 21a; one pixel right 21b; one pixel down 21c and one pixel left 21d.

The four images 20a-20d are screened by the masks such that where the screens pixels are black the image pixels become white. Thus each original image is reduced to an array of black pixels corresponding to the white pixels in the mask to thereby produce the encoded primary images 22a-22d.

The four encoded primary images are combined such that if a black pixel occurs in a primary encoded image 21a-21d it is black in the secondary image if it is white it is ignored.

The secondary image 23 can be animated by moving any one of the screening (decoding) masks over the top such that each primary image in the sequence becomes visible in order.

### EXAMPLE 5

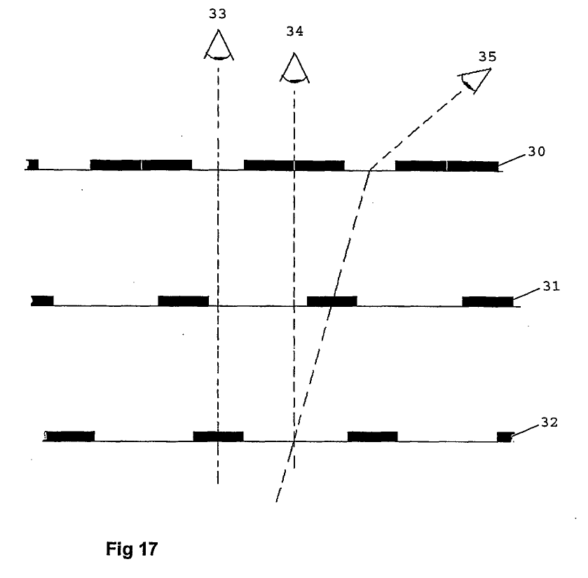

The security device of the example shown in FIG. 17 is made in accordance with the fourth embodiment and comprises an upper 30 and lower 31 decoding masks with a layer between containing the secondary image. The two masks 30,32 are arranged to completely eclipse each other. In this way the device will appear opaque when viewed perpendicular to the surface of the security device. Producing a completely opaque security device can be important on card scanning devices that use light to detect the presence of the card. Thus, the security image cannot be observed from positions 33 or 34 but can be seen from position 35.

Persons skilled in the art will appreciate that various modifications can be made to the present invention without departing from the scope of the invention. These and other modifications will be apparent to those skilled in the art.

1. A security device comprising:
a secondary image comprising one or more encoded primary images, each of said one or more encoded primary images comprising a plurality of regularly sized and spaced apart primary image elements; and
a decoding mask separated from the secondary image, the decoding mask having a plurality of regularly spaced apart transparent viewing portions separated by masking portions, the size and spacing of the viewing portions being such that when said viewing portions of the mask, said secondary image and an observer are located in or more predetermined alignments for each said one or more encoded primary images, the primary image elements from the secondary image may be observed through the viewing portions, whereby the corresponding primary image may be observed along a line of sight corresponding to said predetermined alignment.

2. A security device as claimed in claim 1 wherein the secondary image comprises a plurality of encoded primary images, the primary images being arranged such that each of the primary images may be observed in different predetermined alignments of the mask, the secondary image, and the observer.

3. A security device as claimed in claim 2, wherein each encoded primary image is arranged in at least partial overlapping relationship with at least one other primary image with at least one primary image element located within a boundary of the primary image.

4. A security device as claimed in claim 2, wherein the encoded primary images are related and located relative to one another so as to produce an animation effect as successive primary images are observed.

5. A security device as claimed in claim 4, wherein the encoded primary images are related by encoding the same primary image so as to produce an animation effect of the primary image moving.

6. A security device as claimed in claim 4, wherein the encoded primary images are related by encoding similar primary images so as to produce an animation effect of parts of an image moving.

7. A security device as claimed in claim 1, where the area of each image element is in the range 1×10⁻¹⁴m² to 4×10⁻⁸m².

8. A security device as claimed in claim 1, where the area of each image element is in the 1×10⁻¹²m² to 2.5×10⁻⁹m².

9. A security device as claimed in claim 1, where the image elements are square and each side of the square has a length in the range of 0.1 μm to 200 μm.

10. A security device as claimed in claim 2, wherein the image elements are sized and spaced such that the secondary image comprises four encoded primary images.

11. A security device as claimed in claim 2, wherein there are N primary images and N-1 masking portions for each viewing portion.

12. A security device as claimed in claim 11, wherein the decoding mask comprises a plurality of evenly spaced, opaque vertical and horizontal lines which define therebetween the viewing portions, the lines providing the masking portions.

13. A security device as claimed in claim 12, wherein the vertical and horizontal lines are different, contrasting colours to one another.

14. A security device as claimed in claim 2, wherein the primary image elements of each encoded primary image are of a different colour to the primary image elements of each of the other encoded primary images.

15. A security device as claimed in claim 2, wherein the primary image elements are coloured and the colour and size of the primary image elements are chosen such that the secondary image has the appearance of a grey-scale image.

16. A security device as claimed in claim 2, wherein the secondary image has a boundary defining the set of image elements which provide the secondary image and within the boundary any image elements not provided by primary image elements are provided by additional obscuring image elements.

17. A security device as claimed in claim 16, wherein the additional obscuring image elements are randomly selected.

18. A security device as claimed in claim 1, wherein at least one of said secondary image and said decoding mask is printed within a transparent material to thereby prevent tampering.

19. A security device as claimed in claim 1, wherein both said secondary image and said decoding mask are printed within a transparent material to thereby prevent tampering.

20. A security device as claimed in claim 1, wherein the colours of at least one of the decoding mask and/or at least one of said one or more primary images are chosen to enhance the effect of at least one of said one or more primary images coming into alignment.

21. A security device as claimed in claim 1, wherein the size of the image elements are chosen to vary such that the primary image elements appear to be the same size at a desired viewing distance.

22. A security device as claimed in claim 1, wherein said predetermined alignment is chosen such that each of the one or more primary images cannot be observed by an observer observing the security device along a line of sight substantially perpendicular to the plane in which the decoding mask is located.

23. A security device as claimed in claim 22, wherein there is only one primary image.

24. A security device as claimed in claim 22, wherein there are two different primary images which can be observed along lines of sight at different angles relative to the plane in which the secondary image is located.

25. A security device as claimed in claim 22, further comprising a blocking mask located on the opposite side of the secondary image to the decoding mask and separated from the secondary image by an additional separator.

26. A security device as claimed in claim 22, where the area of each image element is in the range 1×10⁻⁴m² to 4×10⁻⁸m².

27. A security device as claimed in claim 22, where the area of each image element is in the range 1×10⁻¹²m² to 2.5×10⁻⁹m².

28. A security device as claimed in claim 22, where the image elements are square and each side of the square has a length in the range of 0.1 μm to 200 μm.

29. A security device as claimed in claim 22, wherein the decoding mask comprises a plurality of evenly spaced opaque vertical lines which define therebetween the viewing portions, the lines providing the masking portions.

30. A security device as claimed in claim 22, wherein at least one of said secondary image and said decoding mask is printed within a transparent material to thereby prevent tampering.

31. A security device as claimed in claim 22, wherein both of said secondary image and said decoding mask are printed within a transparent material to thereby prevent tampering.

32. A security device as claimed in claim 22, wherein the spacing of the image elements is chosen such that a digital image acquirer cannot capture the secondary image.

33. A security device as claimed in claim 22, wherein the size of the image elements are chosen to vary so that the primary image elements appear to be the same size at a predetermined viewing distance.

34. A security device as claimed in claim 22, wherein at least some of the other image elements are transparent.

35. A security device as claimed in claim 24, wherein all the image elements not belonging to either of the primary images are transparent.

36. A security device as claimed in claim 1, wherein there is only one encoded primary image containing information of interest and wherein said decoding mask is positioned relative to said secondary image such that said primary image can only be observed by an observer observing the security device along a line of sight substantially perpendicular to the plane in which the decoding mask is located.

37. A security device as claimed in claim 36, further comprising a blocking mask located on the opposite side of the secondary image to the decoding mask and separated from the secondary image by an additional separator.

38. A security device as claimed in claim 36, where the area of each image element is in the range 1×10⁻¹⁴m² to 4×10⁻⁸m².

39. A security device as claimed in claim 36, where the area of each image element is in the range 1×10⁻¹²m² to 2.5×10⁻⁹m².

40. A security device as claimed in claim 36, where the image elements are square and each side of the square has a length in the range of 0.1 μm to 200 μm.

41. A security device as claimed in claim 36, wherein the decoding mask comprises a plurality of evenly spaced opaque vertical lines which define therebetween the viewing portions, the lines providing the masking portions.

42. A security device as claimed in claim 36, wherein at least one of said secondary image and said decoding mask is printed within a transparent material to thereby prevent tampering.

43. A security device as claimed in claim 36, wherein both of said secondary image and said decoding mask are printed within a transparent material to thereby prevent tampering.

44. A security device as claimed in claim 36, wherein the spacing of the image elements is chosen such that a digital image acquirer cannot capture the secondary image.

45. A security device as claimed in claim 36, wherein the size of the image elements is chosen to vary so that the primary image elements appear to be the same size at a predetermined viewing distance.

46. A security apparatus comprising:
a security device adapted to be provided on or as part of an item to be secured, the security device comprising a secondary image comprising one or more encoded primary images, each of said one or more encoded primary images comprising a plurality of regularly sized and spaced apart primary image elements; and
a decoding mask having a plurality of regularly spaced apart viewing portions separated by masking portions, the size and spacing of the viewing portions being such that at a predetermined separation between the mask and the secondary image and when said viewing portions of the mask, said secondary image and an observer are in one or more predetermined alignments for each said one or more encoded primary images, the primary image elements of the aligned primary image of the secondary image may be observed through the viewing portions, whereby the corresponding primary image may be observed along a line of sight corresponding to said predetermined alignment.

47. A security apparatus as claimed in claim 46, wherein said security device comprises a plurality of encoded primary images, the primary images being arranged such that each of the primary images may be observed in different predetermined alignments of the mask, the secondary image, and an observer.

48. Apparatus as claimed in claim 47, wherein each encoded primary image is arranged in at least partial overlapping relationship with at least one other primary image with one or more primary image elements located within a boundary of the at least the other primary image.

49. Apparatus as claimed in claim 47, wherein the encoded primary images are related so as to produce an animation effect as successive primary images are observed.

50. Apparatus as claimed in claim 49, wherein the encoded primary images are related by encoding the same primary image so as to produce an animation effect of the primary image moving.

51. Apparatus as claimed in claim 49, wherein the encoded primary images are related by encoding similar primary images so as to produce an animation effect of parts of the primary image moving.

52. Apparatus as claimed in claim 46, where the area of each image element is in the range 1×10⁻¹⁴m² to 4×10⁻⁸m².

53. Apparatus as claimed in claim 46, where the area of each image element is in the range 1×10⁻¹²m² to 2.5×10⁻⁹m².

54. Apparatus as claimed in claim 46, where the image elements are square and each side of the square has a length in the range of 0.1 μm to 100 μm.

55. Apparatus as claimed in claim 47, wherein the image elements are sized and spaced such that the secondary image comprises four encoded primary images.

56. Apparatus as claimed in claim 46, wherein the mask comprises a screen formed from a plurality of evenly spaced, opaque vertical and horizontal lines which define therebetween the viewing portions, the lines providing the masking portions

57. Apparatus as claimed in claim 56, wherein the vertical and horizontal lines are different colours to one another.

58. Apparatus as claimed in claim 57, wherein the different colours are chosen to be contrasting.

59. Apparatus as claimed in claim 47, wherein the image elements of each of said one or more primary images are of a different colour to the image elements of each of the other primary images.

60. Apparatus as claimed in claim 46, wherein the colours of each of said one or more primary images are chosen such that the secondary image has the appearance of a grey-scale image until the decoding mask, the observer and secondary image are in one of said one or more predetermined alignments.

61. Apparatus as claimed in claim 46, wherein the secondary image has a boundary defining the set of image elements which provide the secondary image and within that boundary any image elements not provided by image elements of the encoded primary images are provided by additional obscuring image elements.

62. Apparatus as claimed in claim 61, wherein the additional obscuring image elements are randomly selected.

63. Apparatus as claimed in claim 46, further comprising a transparent separator having a thickness corresponding to said predetermined separation.

64. Apparatus as claimed in claim 46, wherein at least one of said security device and said decoding mask is formed on said separator.

65. Apparatus as claimed in claim 46, wherein at least one of said security device and said decoding mask is printed within a transparent material to thereby prevent tampering.

66. Apparatus as claimed in claim 46, wherein both said security device and said decoding mask are printed within a transparent material to thereby prevent tampering.

67. Apparatus as claimed in claim 46, wherein the decoding mask and secondary image are provided at spaced apart locations on the same piece of material in such a manner that the material can be folded so as to locate the decoding mask over the secondary image and move the decoding mask relative to the secondary image to view each of the primary images.

68. A method of securing an item comprising:
providing a security device adapted to be provided on or as part of an item to be secured, the security device comprising a secondary image comprising one or more encoded primary images, each of said one or more encoded primary images comprising a plurality of regularly sized and spaced apart primary image elements;
providing a decoding mask having a plurality of regularly spaced apart viewing portions separated by masking portions, the size and spacing of the viewing portions being such that at a predetermined separation between the mask and the secondary image and when said viewing portions of the mask, said secondary image and an observer are in one or more predetermined alignments for each said one or more encoded primary images, the primary image elements of the aligned primary image of the secondary image may be observed through the viewing portions, whereby the corresponding primary image may be observed along a line of sight corresponding to said predetermined alignment.

69. A method of securing an item as claimed in claim 68, wherein said security device comprises a plurality of encoded primary images, and method involves arranging the primary images such that each of the primary images may be observed in different predetermined alignments of the mask, the secondary image, and an observer.

70. A method of securing an item as claimed in claim 69, further comprising arranging each encoded primary image in at least partial overlapping relationship with at least one other primary image with one or more primary image elements located within a boundary of the at least the other primary image.

71. A method of securing an item as claimed in claim 70, further comprising relating the encoded primary images so as to produce an animation effect as successive primary images are observed.

72. A method as claimed in claim 71, wherein the encoded primary images are related by encoding the same primary image so as to produce an animation effect of the primary image moving.

73. A method as claimed in claim 71, wherein the encoded primary images are related by encoding similar primary images so as to produce an animation effect of parts of the primary image moving.

74. A method as claimed in claim 69, comprising providing four encoded primary images.

75. Apparatus as claimed in claim 46, comprising providing a screen formed from a plurality of evenly spaced, opaque vertical and horizontal lines which define therebetween the viewing portions, the lines providing the masking portions

76. A method as claimed in claim 75, wherein the vertical and horizontal lines are different colours to one another.

77. A method as claimed in claim 76, wherein the different colours are chosen to be contrasting.

78. A method as claimed in claim 68, comprising selecting the colours of each of said one or more primary images such that the secondary image has the appearance of a grey-scale image until the decoding mask, the observer and secondary image are in one of said one or more predetermined alignments.

79. A method as claimed in claim 68, further comprises providing a transparent separator having a thickness corresponding to said predetermined separation.

80. A method as claimed in claim 79, comprising providing at least one of said security device and said decoding mask is formed on said separator.

81. A method as claimed in claim 79, comprising providing at least one of said security device and said decoding mask by printing it within a transparent material to thereby prevent tampering.

82. A device as claimed in claim 1, wherein portions of said secondary image are separated from said decoding mask by different predetermined distances.
